(19) United States
(12) Patent Application Publication
(10) Pub. No.: US 2014/0067451 A1
(43) Pub. Date: Mar. 6, 2014

(54) Hybrid Multi-Iterative Crowdsourcing System

(71) Applicants: Chithralekha Balamurugan, Pondicherry (IN); Nischal Piratla, Tilaknagar (IN); Shourya Roy, Challaghatta (IN)

(72) Inventors: Chithralekha Balamurugan, Pondicherry (IN); Nischal Piratla, Tilaknagar (IN); Shourya Roy, Challaghatta (IN)

(73) Assignee: Xerox Corporation, Norwalk, CT (US)

(21) Appl. No.: 13/599,027

(22) Filed: Aug. 30, 2012

(51) Int. Cl. G06Q 10/06

(52) U.S. Cl. 705/7.14; 705/7.13

(57) ABSTRACT

The application discloses multi-iterative crowdsourcing systems and methods. Improvements and validations of a crowdsourced job are integrated into the execution process. A job is completed in multiple iterations, with incentives, including reputation enhancements, being provided to users at each iteration. The crowdsourcer has the flexibility to determine the number of iterations, the duration of a job and the incentives and reputation enhancements for each iteration and function.

### FIELD

The present application relates to crowdsourcing systems and methods. More particularly, the present application relates to a hybrid multi-iterative crowdsourcing system with improved quality of job output and robust reputation management.

### BACKGROUND

Crowdsourcing represents the act of a company or institution taking a function once performed by employees and outsourcing it to an undefined, generally large group of people in the form of an open call, beyond the boundaries of an organization and, preferably, at a cheaper cost. Crowdsourcing systems typically provide information describing tasks and, for each task, state a reward and a time period. During the time period users compete to provide the best submission. At the conclusion of the period, a subset of submissions is selected and the corresponding users are granted the reward. Examples of tasks found on existing crowdsourcing web sites are: the graphical design of logos, the creation of a marketing plan, the identification and labeling of an image, and the answering of an individual's question.

The rewards offered for crowdsourced tasks may be monetary or non-monetary. Non-monetary rewards can take the form of reputation points, such as, for example, in community question and answer sites, and confer a measure of social status within these communities.

Presently available and newly proliferating crowdsourcing platforms employ a variety of techniques in order to ensure the quality of work done. Some of these techniques include worker assessment and continual rating, job allocation according to worker's skills, peer review of the work done, random spot testing, among other fields. These approaches, however, do not work well for jobs that require advanced skills where quality assurance may be far more complex, such as algorithm design, software development, translation, building architecture design, among other fields. For example, in a usual software development scenario where a job is not crowdsourced, code review and quality assurance testing are employed to determine the quality of the output. This is not the case with crowdsourced work, however, unless the same work is posted again as a job. This creates issues in ensuring the quality of work being done by the crowd.

Existing R&D or design crowdsourcing platforms do not encourage optimal improvements, as the improvements are limited only to the performer who is assigned the job or whose job submission is selected in a competition, thereby thwarting the “open” flavor of crowdsourcing. Also, within the crowdsourcing platforms, it is difficult for crowdsourcers to provide the right mix of incentives in terms of both monetary rewards and reputation to motivate sufficient numbers of users to make submissions for a given task, participate in improvements, or follow iterations of a job. Neither a pure monetary incentive nor or a pure reputation incentive are good enough to verify the correctness of improvements. Further, none of the existing crowdsourcing platforms provide reputation management for multiple iterations on a single job. In most of the systems, reputations are simply binary assignments, such as, for example, buyer rates seller and seller rates buyer, and not suitable for multi-iterative quality improvement.

Improvement iterations are not available in conventional platforms which facilitate a variety of complex tasks including those of algorithm design, software development, and translation though quality assurance of work done is supported. Also, such platforms lack a good reputation system for workers, with the creation and grant of reputations often being limited by the rate at which the workers' completed tasks are accepted by requesters.

Existing crowdsourcing methods are thus limited in their ability to derive the best quality work from the crowd. Hence, there is need for an improved crowdsourcing system and method that is adapted to ensuring the quality of a job by including improvements and validations through multiple iterations. At the same time, such a system should be attractive for performers and offer them incentives and reputation enhancements corresponding to multi-iterative nature of the job.

### SUMMARY

In one embodiment, the application discloses a multi-iterative crowdsourcing system and method which stand on its own or be integrated into existing crowdsourcing platforms. Besides execution, improvements and validations of the work done are also crowdsourced. A job is completed in multiple iterations, with incentives, including reputation enhancements, being provided to the performers at each iteration. The crowdsourcer has the flexibility to determine number of iterations, duration of job and the incentives and reputation enhancements for each iteration and function.

In one embodiment, the present specification discloses a non-volatile computer readable medium storing a plurality of programmatic instructions, wherein said programmatic instructions, when executed by a processor, cause a computing device to: a) receive, via a network, a posting of a crowdsourced job from a first user wherein said crowdsourced job comprises a plurality of first characteristics, b) present to said first user, via a network, a request for defining a plurality of iterations for executing, improving and/or validating said crowdsourced job, said plurality of iterations defined by a plurality of second characteristics, c) receive from said first user, via a network, a plurality of parameters defining said plurality of second characteristics for the plurality of iterations, d) post said crowdsourced job, e) receive an output from a second user, via a network, wherein said output is responsive to a first iteration of said crowdsourced job, f) determine a value to be transferred to said second user for said first iteration based on said plurality of first characteristics, g) determine a second iteration to be performed based on said plurality of second characteristics, and h) qualify the second user or a third user to perform a second iteration of said crowdsourced job.

Optionally, the programmatic instructions, when executed by a processor, further cause a computing device to: receive an output from the third user, via a network, wherein said output is responsive to the second iteration of said crowdsourced job and determine a value to be transferred to said third user for said second iteration based on said plurality of second characteristics.

Optionally, the programmatic instructions, when executed by a processor, further cause a computing device to determine whether to engage in a third iteration of said crowdsourced job based on said plurality of second characteristics.

Optionally, the plurality of first characteristics include at least one of a due date, required data, required expertise to perform said job, guidelines to perform said job, problems encountered, or expected deliverables. The plurality of second characteristics include at least one of a number of iterations, a qualification, iteration contribution, experience, or reputation in prior jobs for a user eligible to perform an iteration, a type of iteration, or an amount of value and reputation to be transferred to a user for performing an iteration. The second user is not qualified to perform the second iteration of said crowdsourced job if said second iteration is a validation of an executed job.

Optionally, the third user is qualified to perform the second iteration of said crowdsourced job if a reputation of the third user satisfies at least one of said plurality of second characteristics. Neither said second user nor said third user is qualified to perform the second iteration of said crowdsourced job if a due date for said crowdsourced job is exceeded. The second user is qualified to perform the second iteration of said crowdsourced job if said second iteration is an improvement of an executed job. The second iteration is either an improvement iteration or a validation iteration.

In another embodiment, the present specification discloses a method of crowdsourcing a job comprising: a) receiving, via a network, a posting of the crowdsourced job from a first user wherein said crowdsourced job comprises a plurality of first characteristics, b) presenting to said first user, via a network, a request for defining a plurality of iterations for improving or validating said crowdsourced job, said plurality of iterations defined by a plurality of second characteristics, c) receiving from said first user, via a network, a plurality of parameters defining said plurality of second characteristics for the plurality of iterations, d) posting said crowdsourced job, e) receiving an output from a second user, via a network, wherein said output is responsive to a first iteration of said crowdsourced job, f) determining a second iteration to be performed based on said plurality of second characteristics, g) qualifying the second user or a third user to perform a second iteration of said crowdsourced job, h) receiving an output from the second user or third user, via a network, wherein said output is responsive to the second iteration of said crowdsourced job, and i) determining a third iteration to be performed based on said plurality of second characteristics.

Optionally, the method further comprises: a) determining that the second iteration is a validation iteration, b) qualifying the third user, and not the second user, to perform the second iteration, c) receiving an output from the third user, via a network, wherein said output is responsive to the second iteration of said crowdsourced job, and d) determining a value to be transferred to said third user for said second iteration based on said plurality of second characteristics.

Optionally, the method further comprises determining whether to engage in a third iteration of said crowdsourced job based on said plurality of second characteristics.

Optionally, the method further comprises: a) determining that the second iteration is an improvement iteration, b) qualifying the second user, and not the third user, to perform the second iteration, c) receiving an output from the second user, via a network, wherein said output is responsive to the second iteration of said crowdsourced job, and d) determining a value to be transferred to said second user for said second iteration based on said plurality of second characteristics.

Optionally, the method further comprises determining whether to engage in a third iteration of said crowdsourced job based on said plurality of second characteristics. The plurality of first characteristics include at least one of a due date, required data, required expertise to perform said job, guidelines to perform said job, problems encountered, or expected deliverables. The plurality of second characteristics include at least one of a number of iterations, a qualification, iteration contribution, experience, or reputation in prior jobs for a user eligible to perform an iteration, a type of iteration, or an amount of value and reputation to be transferred to a user for performing an iteration. The third user is qualified to perform the second iteration of said crowdsourced job only if a reputation of the third user satisfies at least one of said plurality of second characteristics. Neither said second user nor said third user is qualified to perform the second iteration of said crowdsourced job if a due date for said crowdsourced job is exceeded. The second user is qualified to perform the second iteration of said crowdsourced job only if a reputation of the second user satisfies at least one of said plurality of second characteristics.

The aforementioned and other embodiments of the present shall be described in greater depth in the drawings and detailed description provided below.

### BRIEF DESCRIPTION OF THE DRAWINGS

These and other features and advantages will be appreciated as they become better understood by reference to the following Detailed Description when considered in connection with the accompanying drawings, wherein:

FIG. 1 is a schematic diagram of an exemplary crowdsourcing system;

FIG. 2 is a flowchart illustrating how the execution function for a job is carried out in an exemplary crowdsourcing system;

FIG. 3 is a flowchart detailing an exemplary process of carrying out improvement and validation functions for a job;

FIG. 4 is a first graph depicting a uniform distribution of payments and reputations, according to one embodiment;

FIG. 5a a second graph depicting a directly proportional, iteration-based distribution of payments;

FIG. 5a a third graph depicting a directly proportional, iteration-based distribution of reputations;

FIG. 6a is a fourth graph depicting an inversely proportional, iteration-based distribution of reputations;

FIG. 6a is a fifth graph depicting an inversely proportional, iteration-based distribution of payments; and

FIG. 7 is a sixth graph depicting function-based distribution of payments and reputations, according to one embodiment.

### DETAILED DESCRIPTION

The present application discloses multiple embodiments. The following disclosure is provided in order to enable a person having ordinary skill in the art to practice the claimed inventions. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present application is to be accorded the widest scope encompassing numerous alternatives, modifications and equivalents consistent with the principles and features disclosed. For purpose of clarity, details relating to technical material that is known in the technical fields related to the claimed inventions have not been described in detail so as not to unnecessarily obscure the disclosure.

In one embodiment, the present application discloses a hybrid multi-iterative crowdsourcing method which can be a standalone system or integrated into existing crowdsourcing platforms. The multi-iterative crowdsourcing method provides a quality job output by enabling improvements and validations of the work done through incentives at multiple iterations. Iteration-linked incentives and reputations motivate performers to contribute their best in job execution, improvement and validation.

As used herein, the term ‘crowdsourcing’ broadly encompasses the act of taking a job traditionally performed by a designated individual or group of individuals known, vetted, hired, and/or contracted by an entity (usually employees) and, instead, offering the job to a group of people, who are not part of, or previously contracted by, the entity, in the form of an open, broadcasted call or request that is made electronically accessible through a wired or wireless network. The term ‘crowdsourcer’ as used herein refers to the entity that broadcast the job, including the parameters or characteristics defined the job, for crowdsourcing. The entity may include one or more individuals, businesses, enterprises, partnerships, corporations, joint ventures, government entities, non-profits, or other organizations. The term ‘job’ or ‘crowdsourced job’ as used herein refers to a task, request, or set of parameters defining a service or product that an entity wants completed and is offering to a group of people, who are not part of, or previously contracted by, the entity, in the form of an open, broadcasted call that is made electronically accessible through a wired or wireless network. The set of parameters that define a service may, in one embodiment, include specification of the problem, data required to perform the job, expertise required to perform the job, guidelines to perform the job, expected deliverable, due date, among other quantitative and qualitative variables.

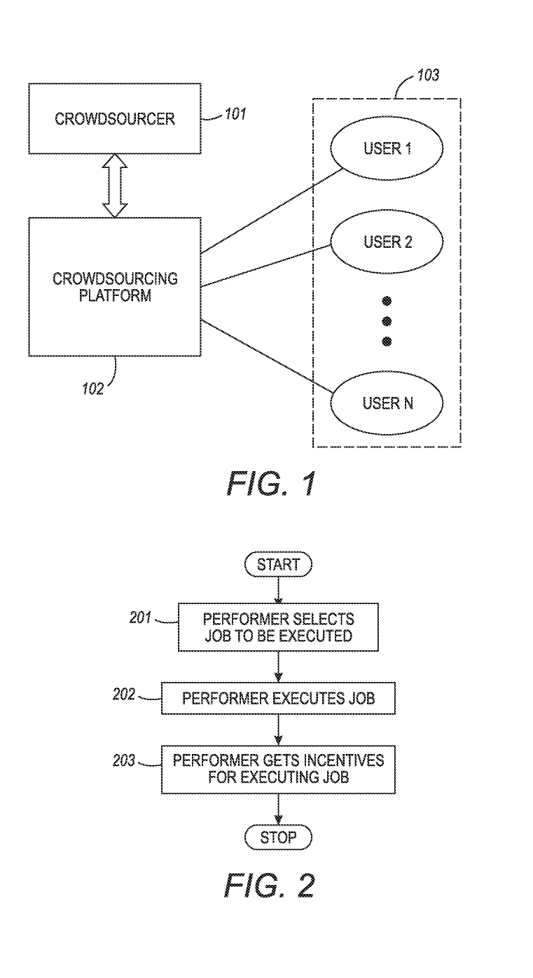

FIG. 1 is a schematic diagram of a crowdsourcing system. Referring to FIG. 1, the system comprises a crowdsourcing platform 102, which can be used by crowdsourcers 101 to offer tasks to participants. The crowdsourcing platform 102 is provided using a web server or other computing device which is connected to a communications network such as the Internet or other wireless or wired communications network. This enables the crowdsourcing platform to be in communication with a large scale population of users 103. Users 103 are potential participants who can access and work on the tasks posted by the crowdsourcer 101, by means of graphical user interfaces generated by the platform 102 and transmitted to the users' 103 client computing devices for display. Optionally, a system operator (not shown) is also in communication with the crowdsourcing platform and act as a provider of the crowdsourcing service. However, it is not essential for a system operator to be present. The crowdsourcing platform may be operated by multiple crowdsourcers in a collaborative manner.

The crowdsourcing platform stores or has access to details of a plurality of jobs or tasks posted by crowdsourcers, each having an associated reward. Each job or task also has a defined time period for completing the task. The publisher (crowdsourcer) for each job or task may be different, but this is not essential.

It should be appreciated that the crowdsourcing platform preferably has operational features common to, and known by, individuals of ordinary skill in the art, including the ability to electronically solicit and receive profile information of crowdsourcers and users, to electronically solicit and receive IDs and passwords to enable crowdsourcers and users to securely log-in to the platform, to electronically store and present upon request account information to enable crowdsourcers and users to modify their profile, view historical activity, view a rewards, value, or other financial account, and/or view communications with other entities who are participating in the crowdsourcing platform. It should further be appreciated that the crowdsourcing platform provides the aforementioned functions, and the other functions described herein, by executing a plurality of programmatic instructions, which are stored in one or more non-volatile memories, using one or more processors and presents and/or receives data through transceivers in data communication with one or more wired or wireless networks.

Crowdsourcing platforms may adopt different crowdsourcing models such as a competition based model, a collaborative model or a contract worker model. In the competition based model, the crowdsourcer registers a job in the crowdsourcing platform as an open challenge or a competition with a defined prize for the winner. Users opt for engaging in the competition and proceed to perform the job and post his or her end product in conformance with the job description. The crowdsourcer who registered the job then evaluates the outputs from the users and selects a winner. This competition model is mostly implemented in research and development or logo design crowdsourcing platforms where the R&D problems and design challenges are hosted as contests.

The collaborative model is also mostly used for idea development or creative design where the idea or the design is conceptualized, reviewed, improved, and evaluated by a closed group of users selected by the crowdsourcer or the open crowd. In the contract worker model, several users register themselves with their area of specialization with the crowdsourcing platform. When a crowdsourcer needs a job to be executed, the job is either pushed by the crowdsourcer to a selected contract worker or it is pulled by the registered contract worker who wishes to work on it. Controls available in the platform help to check certain characteristics of the delivered output, such as whether it is on time, and rate the performers based on output. However, if the crowdsourcer needs to improve the job done or wishes to get the quality of the work validated by the open crowd, it requires the crowdsourcer to submit an entirely new job.

The present application describes a multi-iterative crowdsourcing system that integrates improvements and validation within the process, thereby addressing the problem of existing crowdsourcing systems. In one embodiment, the present crowdsourcing system carries out functions such as an execution (E) of a job, a validation (V) of a job, and an improvement (I) of a job in the multiple iterations. In one embodiment, all these functions are independently crowdsourced functions carried out in the different iterations.

Integrated with enabling the execution of a new job, validations and improvements are also enabled for a job whose initial execution has been completed. The job is crowdsourced for each validation and improvement iteration. FIG. 2 illustrates how an execution function is carried out. After a crowdsourcer posts a job on a crowdsourcing platform, a user interested in engaging in the job selects the job 201 and then executes the job 292. The user is then rewarded 203 with the appropriate incentive for completing the job. The incentive may be monetary, or non-monetary (in the form of virtual currency or reputation points) or a combination of both. In one embodiment, the crowdsourcer determines the incentive for each task, and specifies it at the time of posting the job on the crowdsourcing platform.

After execution, the job may iteratively go through improvement and validation phases. In one embodiment, the number of iterations for validation and improvement is specified by the crowdsourcer. The crowdsourcer also specifies the number of days within which all iterations have to be completed. If the number of days is exceeded, then the remaining iterations are not crowdsourced. In one embodiment, the above functions are mutually exclusive, that is, if a job is in a particular iteration of crowdsourcing, then other iterations cannot start on it.

In one embodiment, validation iteration can be performed only on an executed or improved job and can be only be done by a user other than the one who executed or improved it. Improvement and validation iterations can repeat successively.

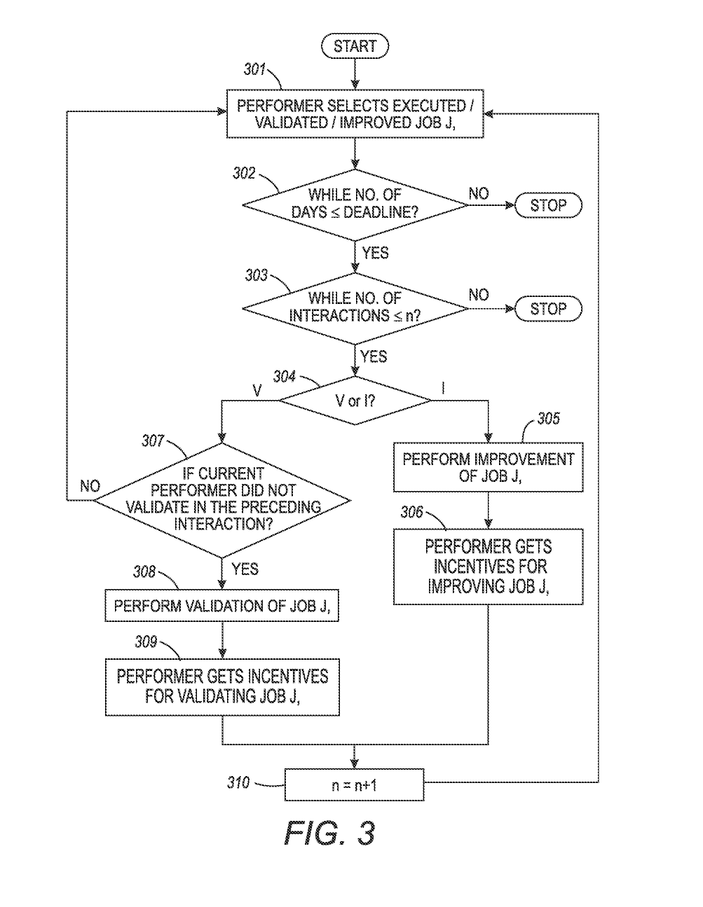

FIG. 3 is a flowchart illustrating one embodiment for enabling improvement and validation functions. This process is integrated within a crowdsourcing platform which is executed by a computing device, such as a web server, and is connected to a communications network, such as the Internet.

Referring to FIG. 3, an executed job Jᵢ is selected for improvement or validation by a user or performer interested in engaging in the task 301. The job may already have gone through a one or more iterations of improvement or validation, in which case an interested user or performer may select it for further enhancement. As mentioned, the crowdsourcer specifies at the time of posting the job the number of iterations for validation and improvement they are willing to accept, along with the total number of days within which all the iterations need to be completed. In one embodiment, the crowdsourcer also specifies the reward linked to each iteration of validation and improvement. Thus, if the number of days is less than the deadline specified 302, and the number of iterations is less than ‘n’, the maximum number specified by the crowdsourcer 303, the process continues.

The system then checks if it is a validation (V) or improvement (I) job 304. In case the job requires improvement, the performer who selected the job works to improve on it 305, and submits the completed job to the crowdsourcing platform. Thereafter, the performer receives an incentive, which may be virtually allocated to the performer's account in the form of virtual currency, reward points, reputation enhancements, or actual money, as specified for that iteration of improvement by the crowdsourcer 306.

In case the job requires validation, the system checks 307 if the performer who has selected the job has not worked on executing, improving or validating the job in a previous iteration. By requiring a different user to validate in a given iteration, the system minimizes the likelihood of collusion and places the onus of quality control on more than one individual, i.e. the original performer of the job. Thus, if the current performer has not worked on the job before, he or she may validate the job 308, and posts the validated result to the crowdsourcing platform. The performer then gets the specified incentive for the validation work 309. If, however, a performer has worked on that job before, he or she may not be allowed to validate the job, and it remains open for validation by another performer. After each cycle of improvement or validation, the number of iterations ‘n’ is increased by one 310, such that the job no longer remains open for the crowd when ‘n’ reaches the maximum the number of iterations specified by the crowdsourcer 311.

It would be apparent to a person of ordinary skill in the art that, in the above described system, the crowdsourcer benefits from the quality of the completed job which has evolved through multiple iterations. The system also allows crowdsourcers to stipulate rewards and deadlines, thereby granting them control over the cost and time taken to get the job done through and within each iterative cycle. Besides ensuring that validation is done by independent performers from the crowd, in one embodiment the crowdsourcer is also able to stipulate quality conditions such as “performers with ‘x’ reputation points may work on the i^{th} iteration of improvement”, or “only performers who have scored maximum reputation in execution phases of algorithm design jobs should take up the execution of this job”, or “only performers who have earned the highest reputation in working in the first improvement phase of all prior jobs should take up the improvement phase of this job”, or “only performers who have scored the highest reputation in the last five architecture design validation jobs should work in the validation phase of this job”, and so on. By having people who have accumulated reputation points in prior jobs work on the various iterations of the posted job, a crowdsourcer can ensure contribution from experienced performers. This would also motivate performers to accumulate reputation points by performing iterative functions in different jobs.

In the present system of crowdsourcing, a job Jᵢ is iteratively acted upon by a set of crowdsourced functions—execution, validation and improvement. The multiple iterations of crowdsourced functions can be represented by the following equation:

CS(Ji)=CS(E(Ji))ΛΣₖ₌₁ⁿCS(Vk(Ji)))|CS(Ik(Ji)), (1)
where CS(Ji)=crowdsourced Job Ji,
CS(E(Ji))=crowdsourced execution function for Ji,
CS(V(Ji))=crowdsourced validation function for Ji,
CS(I(Ji))=crowdsourced improvement function for Ji,
k=number of iterations and n=maximum number of iterations specified by the crowdsourcer.

Thus, equation (1) provides that a crowdsourced Job Ji has an iteration of execution and k iterations of validations and improvements. The execution is carried out in the first iteration, followed by k iterations of validations and improvements, where the maximum value of k is specified by the crowdsourcer. In one embodiment, the system generates a maximum or optimized k based on the degree of validation or quality desired by the user. In another embodiment, the system defines a default k which the user can increase or decrease explicitly or implicitly by defining a lower or higher degree of desired validation or improvement.

The sequencing of crowdsourced functions for a job Ji is captured by the following equation:

MICSn(Ji)=E1(Ji), if E1(Ji)=0 and no. of days d≦deadline (2)

MICSn(Ji)=Vdk(Ji)|Idk(Ji) where ‘d’≦deadline and k≦‘n’ and E1(Ji)=1 (3)
where, MICSn(Ji)=phase (execution, improvement or validation) of crowdsourced job Ji,
E1(Ji)=first iteration of execution for Ji,
Vdk(Ji)=k^{th} iteration of validation for Ji,
Idk(Ji)=k^{th} iteration of improvement for Ji,
d=number of days,
k=number of iterations and n=maximum number of iterations specified by the crowdsourcer.

Thus, equations (2) and (3) provide that a crowdsourced job Ji is in the execution phase if the first iteration of execution has not been completed and the number of days is less than the deadline specified by the crowdsourcer. After the first iteration of execution is completed, the crowdsourced job Ji enters into k^{th} iteration of validation or improvement, as long as k is less than/equal to the maximum number of iterations and the number of days is less than the deadline specified by the crowdsourcer.

A performer who executes or validates or improves a job would be provided with the corresponding incentives and reputation specified by the crowdsourcer. The total incentives ‘In’ obtained by a performer Pi in job Ji is the sum of the payments and reputations obtained by the performer for participating in a subset of the ‘k’ iterations of the job, that is:

In(Pi(Ji))=Σₖ₌₁ⁿPayk(Pi(Ji))+Rk(Pi(Ji) (4)
where In(Pi(Ji))=total incentives obtained by a performer Pi in job Ji,
Payk(Pi(Ji))=payment received by a performer Pi for k^{th} iteration in job Ji,
Rk(Pi(Ji))=reputation received by a performer Pi for k^{th} iteration in job Ji,
k=number of iterations and n=maximum number of iterations specified by the crowdsourcer.

The reputation accumulated by a performer Pi in job Ji can be represented by the following equation:

Rk(Pi(Ji))=Rk−1(Pi(Ji)+R(Vk(Ji)+Ik(Ji)), (5)
where Rk−1(Pi(Ji))=reputation accumulated by performer Pi up to the (k−1)^{a}′ iteration for executing/validating/improving job Ji in prior iterations,
R(Vk(Ji))=reputation specified by crowdsourcer for validating job Ji in the k^{th} iteration, and
R(Ik(Ji)) is the reputation obtained by performer Pi for improving a job.

That is, the total reputation obtained by performer in performing job Ji is the sum of the reputations obtained by him in the various iterations of the crowdsourced job.

To ensure that every iteration function is attractive for performers, incentives, such as payments and reputations, are associated respectively, per iteration. In one embodiment, the distribution pattern of the payments and reputations, per iteration, are specified by the crowdsourcer. The crowdsourcer may specify uniform or varied payments and reputations for the different iterations. Further, the distribution pattern for the payments and reputations could be iteration based, function based or performer based.

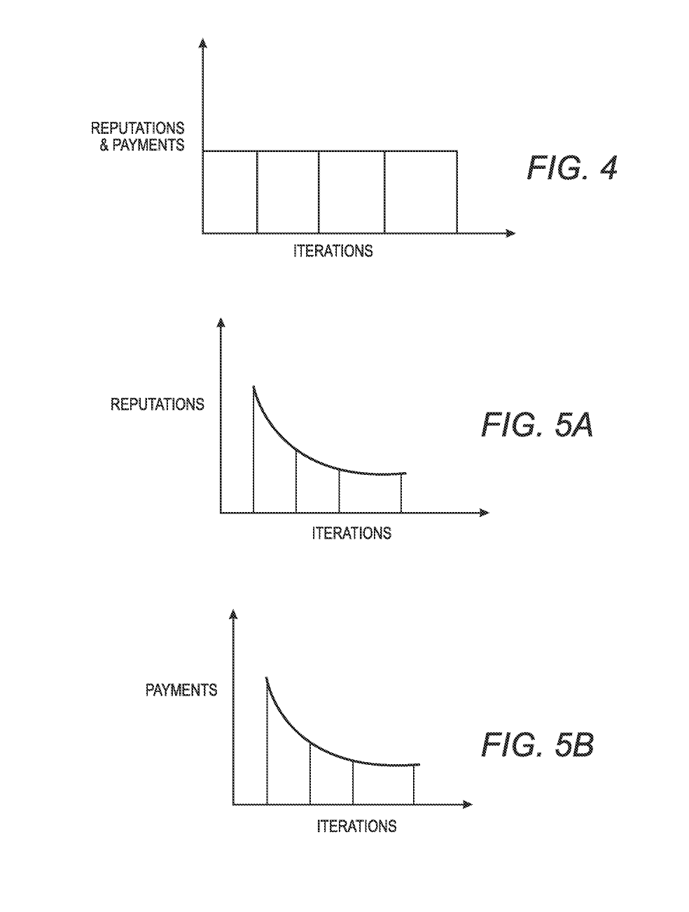

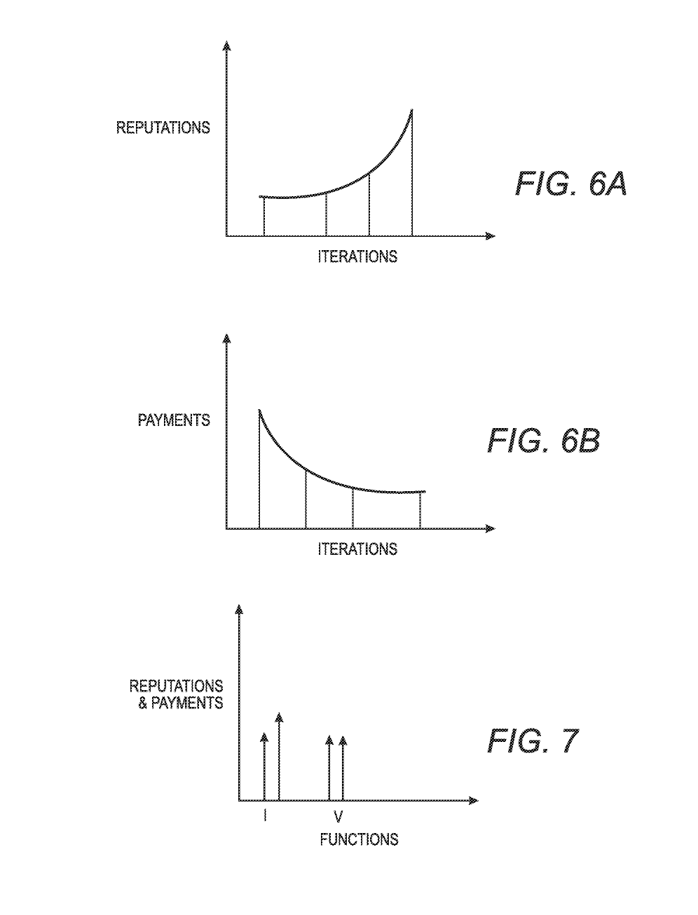

In one embodiment, the crowdsourcer simply specifies a total reward in terms of reputations and payments for the job, including all iterations, and the system creates a default breakdown of payment for performers at each cycle. The break down for the various iterations can be specified in terms of the distribution function, and that is used by the system for splitting the payments and reputation. If a uniform distribution is specified, the payments and reputations are distributed equally for every iteration as shown in FIG. 4. If a directly proportional distribution is specified, the payments and reputation either increase or decrease with the iterations as shown in FIGS. 5a and 5b. If an inversely proportional distribution is specified, the reputations can keep increasing with iterations, while the payments keep decreasing as shown in FIGS. 6a and 6b

FIGS. 4 through 7 illustrate various distribution functions for payments and reputations. Referring to FIG. 4, a uniform distribution of reputation and payments is shown. In a uniform distribution, reputation and payments remain the same for each iteration. FIGS. 5a and 5b illustrate an iteration-based distribution of reputation and payments. In the iteration based approach, the distribution of payments and reputations could be directly proportional or inversely proportional to the number of iterations. In the directly proportional distribution the reputation and payment vary in equal proportions across all the iterations. As shown in FIGS. 5a and 5b, both reputations and payment decrease as the number of iterations increases.

Viewed in combination, FIGS. 6a and 6b illustrate an inversely proportional distribution. In this case, when the reputation increases with each iteration, the payment decreases with every iteration. This would motivate workers to contribute for the validation and improvement phases as they could earn reputations even though the payment is not very rewarding. This is because earning higher reputations would render them eligible to take up jobs where higher reputation requirements are stipulated for working on a particular iterations, as described earlier.

FIG. 7 illustrates another approach, where the incentive distribution is function-based and varies according to the function performed in iteration. In this approach, the payment and incentives are not iteration dependent, but dependent on what task (either validation or improvement) they perform in an iteration Thus, for example, more reputations or payments may be granted for improvement jobs than for validations.

In another approach, the distribution of reputation and payments may be performer-based. Thus, performers with higher reputations could be awarded higher reputations or payments or a combination of these than for other performers in carrying out the iterations.

The present system and method of crowdsourcing overcomes several limitations of prior art. While quality control in existing systems is a disparate function and is not woven into the crowdsourcing execution method, the crowdsourcing method of the present application integrates multiple iterations of improvements and validation.

In existing systems, improvement of work done in a job is facilitated by the performer who has taken up the job whereas in the present system, validations and improvements are done through multiple, individually incentivized iterations of crowdsourcing, thereby effectively utilizing the crowd's talent. Further, many crowdsourcing methods rely on, as well as require, the crowdsourcer's expertise to evaluate and suggest improvements to the work done. In the present case however, the crowd's expertise is used for performing validations and improvements.

Existing systems assess the quality of a performer's work and use it as a factor in any subsequent work allocation to that performer. This kind of quality assessment does not contribute towards the current job being executed. In the system of present application however, validations and improvements are part of current job execution, and quality is continually monitored.

Moreover, even in crowdsourcing methods employing collaborative job execution, where the job is executed collaboratively and peer reviews are incorporated in the job being carried out, it is not supported with suitable incentive system so as to make the peer contributions attractive and competitive. The present crowdsourcing system supported peer contribution towards improvements and validations with a flexible incentive system comprising of payments and reputations. This makes the present crowdsourcing system and method attractive and competitive for both crowdsourcers and performers.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A non-volatile computer readable medium storing a plurality of programmatic instructions, wherein said programmatic instructions, when executed by a processor, cause a computing device to:
Receive, via a network, a posting of a crowdsourced job from a first user wherein said crowdsourced job comprises a plurality of first characteristics;
Present to said first user, via a network, a request for defining a plurality of iterations for executing, improving and/or validating said crowdsourced job, said plurality of iterations defined by a plurality of second characteristics;
Receive from said first user, via a network, a plurality of parameters defining said plurality of second characteristics for the plurality of iterations;
Post said crowdsourced job;
Receive an output from a second user, via a network, wherein said output is responsive to a first iteration of said crowdsourced job;
Determine a value to be transferred to said second user for said first iteration based on said plurality of first characteristics;
Determine a second iteration to be performed based on said plurality of second characteristics; and
Qualify the second user or a third user to perform a second iteration of said crowdsourced job.

2. The non-volatile computer readable medium of claim 1 wherein said programmatic instructions, when executed by a processor, further cause a computing device to:
Receive an output from the third user, via a network, wherein said output is responsive to the second iteration of said crowdsourced job; and
Determine a value to be transferred to said third user for said second iteration based on said plurality of second characteristics.

3. The non-volatile computer readable medium of claim 2 wherein said programmatic instructions, when executed by a processor, further cause a computing device to determine whether to engage in a third iteration of said crowdsourced job based on said plurality of second characteristics.

4. The non-volatile computer readable medium of claim 1 wherein said plurality of first characteristics include at least one of a due date, required data, required expertise to perform said job, guidelines to perform said job, problems encountered, or expected deliverables.

5. The non-volatile computer readable medium of claim 1 wherein said plurality of second characteristics include at least one of a number of iterations, a qualification, iteration contribution, experience, or reputation in prior jobs for a user eligible to perform an iteration, a type of iteration, or an amount of value and reputation to be transferred to a user for performing an iteration.

6. The non-volatile computer readable medium of claim 1 wherein said second user is not qualified to perform the second iteration of said crowdsourced job if said second iteration is a validation of an executed job.

7. The non-volatile computer readable medium of claim 1 wherein said third user is qualified to perform the second iteration of said crowdsourced job if a reputation of the third user satisfies at least one of said plurality of second characteristics.

8. The non-volatile computer readable medium of claim 1 wherein neither said second user nor said third user is qualified to perform the second iteration of said crowdsourced job if a due date for said crowdsourced job is exceeded.

9. The non-volatile computer readable medium of claim 1 wherein said second user is qualified to perform the second iteration of said crowdsourced job if said second iteration is an improvement of an executed job.

10. The non-volatile computer readable medium of claim 1 wherein said second iteration is either an improvement iteration or a validation iteration.

11. A method of crowdsourcing a job comprising:
Receiving, via a network, a posting of the crowdsourced job from a first user wherein said crowdsourced job comprises a plurality of first characteristics;
Presenting to said first user, via a network, a request for defining a plurality of iterations for improving or validating said crowdsourced job, said plurality of iterations defined by a plurality of second characteristics;
Receiving from said first user, via a network, a plurality of parameters defining said plurality of second characteristics for the plurality of iterations;
Posting said crowdsourced job;
Receiving an output from a second user, via a network, wherein said output is responsive to a first iteration of said crowdsourced job;
Determining a second iteration to be performed based on said plurality of second characteristics;
Qualifying the second user or a third user to perform a second iteration of said crowdsourced job;
Receiving an output from the second user or third user, via a network, wherein said output is responsive to the second iteration of said crowdsourced job; and
Determining a third iteration to be performed based on said plurality of second characteristics.

12. The method of claim 11 further comprising:
Determining that the second iteration is a validation iteration;
Qualifying the third user, and not the second user, to perform the second iteration;
Receiving an output from the third user, via a network, wherein said output is responsive to the second iteration of said crowdsourced job; and
Determining a value to be transferred to said third user for said second iteration based on said plurality of second characteristics.

13. The method of claim 12 further comprising determining whether to engage in a third iteration of said crowdsourced job based on said plurality of second characteristics.

14. The method of claim 11 further comprising:
Determining that the second iteration is an improvement iteration;
Qualifying the second user, and not the third user, to perform the second iteration;
Receiving an output from the second user, via a network, wherein said output is responsive to the second iteration of said crowdsourced job; and
Determining a value to be transferred to said second user for said second iteration based on said plurality of second characteristics.

15. The method of claim 14 further comprising determining whether to engage in a third iteration of said crowdsourced job based on said plurality of second characteristics.

16. The method of claim 11 wherein said plurality of first characteristics include at least one of a due date, required data, required expertise to perform said job, guidelines to perform said job, problems encountered, or expected deliverables.

17. The method of claim 11 wherein said plurality of second characteristics include at least one of a number of iterations, a qualification, iteration contribution, experience, or reputation in prior jobs for a user eligible to perform an iteration, a type of iteration, or an amount of value and reputation to be transferred to a user for performing an iteration.

18. The method of claim 11 wherein said third user is qualified to perform the second iteration of said crowdsourced job only if a reputation of the third user satisfies at least one of said plurality of second characteristics.

19. The method of claim 11 wherein neither said second user nor said third user is qualified to perform the second iteration of said crowdsourced job if a due date for said crowdsourced job is exceeded.

20. The method of claim 11 wherein said second user is qualified to perform the second iteration of said crowdsourced job only if a reputation of the second user satisfies at least one of said plurality of second characteristics.
